(19) United States
(12) Patent Application Publication
(10) Pub. No.: US 2017/0258266 A1
(43) Pub. Date: Sep. 14, 2017

(54) PASTRY WARMING BEVERAGE CONTAINER APPARATUS

(71) Applicant: Thomas Medwin, Satellite Beach, FL (US)

(72) Inventor: Thomas Medwin, Satellite Beach, FL (US)

(21) Appl. No.: 15/068,864

(22) Filed: Mar. 14, 2016

(51) Int. Cl. A47J 36/24; A47J 36/06; A47J 47/08; A47G 19/22; B65D 25/28

(52) U.S. Cl. CPC A47J 36/24; A47G 19/2272; B65D 25/2802; A47J 47/08; A47J 36/06

(57) ABSTRACT

Embodiments described herein include a beverage container that is configured to provide thermal conductivity from a hot stored liquid to a food product placed onto the planar lid surface. The embodiments are comprised of a uniform thickness porcelain material, which transfers the heat through convection through the planar lid surface into the food product to enable aroma and flavor compounds to be released and provide a warm, tastier food product.

### CROSS-REFERENCE TO RELATED APPLICATION

This application claims the benefit of provisional patent application No. 62/214,235, titled “Beverage Container with Warming Plate” filed on Sep. 8, 2015 by the same inventor Thomas Medwin.

### FIELD

The present embodiment relates to a hot beverage container, and in particular to a hot beverage container apparatus which transfers the heat by convection from the stored liquid contents to a food product placed on a planar lid surface.

### BACKGROUND

Today many popular diners, drive-ins, and convenience stores offer a variety of hot beverages to their customers. Further, many popular coffee and tea shops allow consumers to bring in a traditional beverage container, to be filled with their favorite hot liquid. Many of these consumers quickly grab their beverage container and a popular pastry, and consume their products “on the go.”

During the winter months, many of these beverage containers find further utility as hand warmers, as users tightly grip their sidewalls to absorb as much warmth from the stored liquid as possible. However, the ability to retain and transfer heat is highly dependent on the thickness and composition of the material.

Though there are many different disposable beverage containers with varying configured lids designed to keep a liquid warmer for a prolonged period, there is not a single reference that provides a beverage container which transfers the heat from the stored liquid to a food product.

### SUMMARY OF THE INVENTION

Embodiments described herein include a pastry warming beverage container apparatus. The apparatus is composed of a uniformly thick porcelain material, which provides thermal conductivity through convection from the stored liquid contents to an integrated uniform planar lid surface, which provides even heat transfer to a food product selectively placed on top of the planar lid surface. The embodiments provide a beverage container composed of a material with a high heat transfer coefficient, which includes an integrated planar lid surface and at least one aperture, which absorbs the radiant heat from the liquid and transfers it to the food product, while simultaneously enabling a person to drink the stored liquid contents.

Other aspects, advantages, and novel features of the present invention will become apparent from the following detailed description in conjunction with the drawings.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 is a perspective view of a pastry warming beverage container apparatus;

FIG. 2 is a view of the apparatus while in use;

FIG. 3 is a further view of the apparatus while in use, and

FIG. 4 is a cross-section view of the apparatus.

### DETAILED DESCRIPTION

The specific details of the single embodiment or variety of embodiments described herein are set forth in this application. Any specific details of the embodiments are used for demonstration purposes only and no unnecessary limitations or inferences are to be understood therefrom.

The present embodiment relates to a pastry warming beverage container apparatus. The apparatus provides a beverage container for hot liquids, including an integrated planar lid surface which is configured to enable conductive heat transfer medium from the stored liquid contained within the beverage container to the food item, which is selectively placed on top of the planar lid surface. The apparatus enables a user to keep a food product warm while simultaneously drinking their favorite beverage. For example, the apparatus allows a “person on the go” to fill their beverage container at their favorite coffee, convenience store, or breakfast shop with their preferred hot beverage, place a food item such as a pastry, bagel, or breakfast sandwich on the lid surface of the apparatus, and have a warm, delicious meal when they arrive at their destination without compromising aroma or flavor, which is lost when a food cools. A user may operate the apparatus by simply filling the beverage container with a hot stored liquid, placing the food product onto the planar lid surface for a period of time, and enjoying the food product once it has reached its desired temperature. Simultaneously, the user is able to drink or refill the container at any point through the aperture found in the planar lid surface.

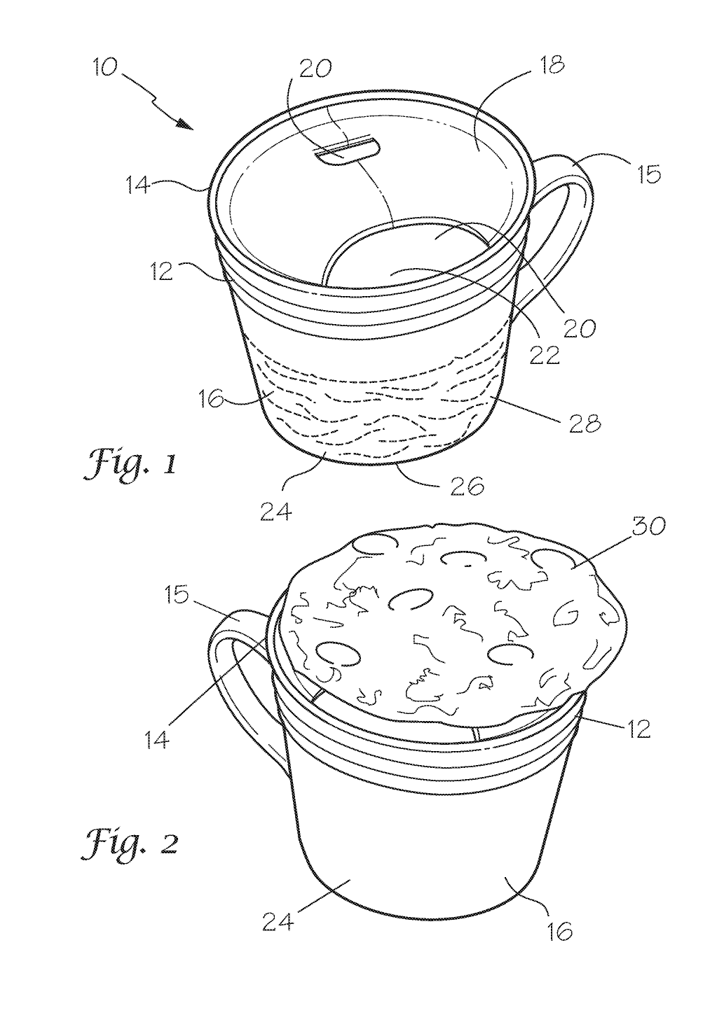

Referring now to the drawings wherein like reference numerals designate identical or corresponding parts throughout the views, there is shown in FIG. 1 a perspective view of a pastry warming beverage container apparatus 10. The apparatus 10 includes a first end 12 connected by a sidewall 14 to the second end 16. The first end 12 further includes a planar lid surface 18 and a plurality of apertures 20, which provide access to the contents contained within the apparatus 10. Further, the first end 12 has a substantially cylindrical configuration defined by a first diameter 22. The second end 16 further includes a second substantially planar surface 24, defined by the second diameter 26, which is slightly smaller than the first diameter 22 and which enables a user to place the apparatus 10 on a variety of objects without tipping over. The sidewall 14 contains the stored liquid contents 28 and further defines the height of the apparatus 10. A handle 15 is attached to the sidewall 14 at both the first end 12 and the second end 16, which helps prevent spilling the contents or burning a portion of the user's hand from contact with the hot sidewalls 14.

Shown in FIG. 2 is a view of the apparatus 10, wherein a food product 30 is placed on the planar lid surface 18. The apparatus 10 further enhances the flavor and aroma of the food product 30 when heated on the planar lid surface 18 by releasing the aromatic and flavor compounds contained within the food. Specifically, over ninety percent of all food flavors are conveyed in the fats and oils of a food product 30. When heated, these volatile compounds release aroma and flavor compounds within the food, and help a user discern the unique tastes to to their palate. The uniform thickness of the planar lid surface 18 and the unique porcelain or ceramic composition provides optimal heat transfer from the stored liquid contents 28 through the planar lid surface 18, which provides a uniform heated medium to the food product 30.

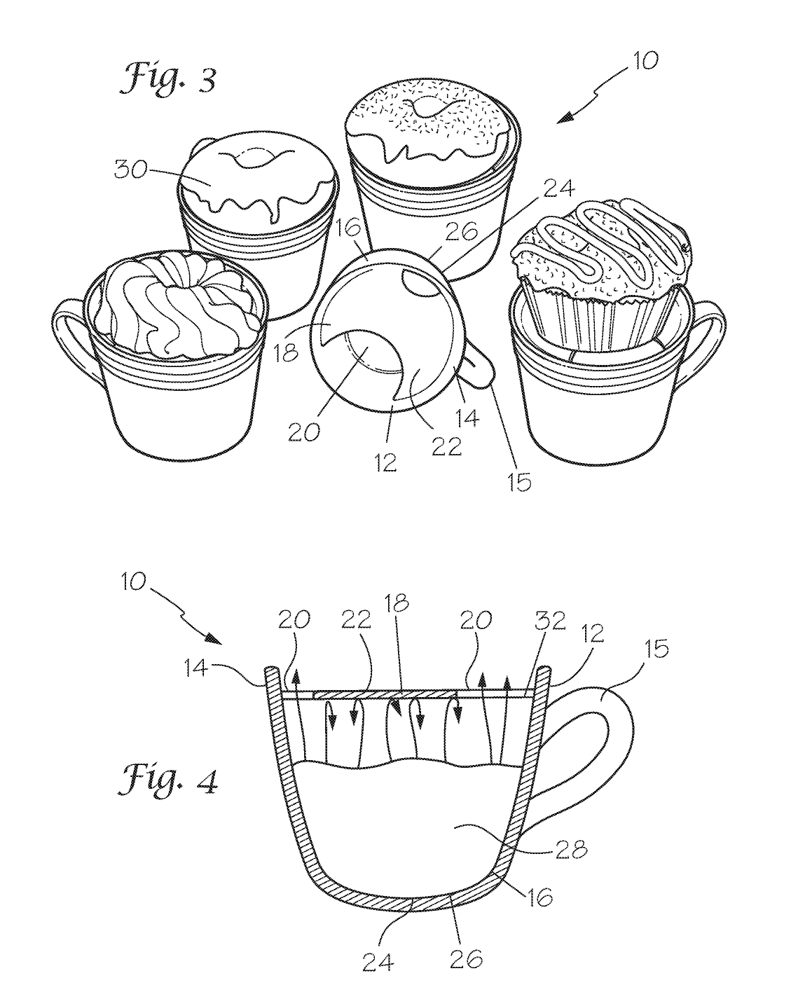

Shown in FIG. 3 is a further view of the apparatus 10 with a food product 30 releasably attached onto the planar lid surface 18. The first diameter 22 is dimensioned to house a variety of popular configured food products 30, such as donuts, muffins, bagels, cupcakes, danish, cookies, etc. However, any food product 30 may used so long as it fits on the top of the planar lid surface 18.

Shown in FIG. 4 is a cross-sectional view of the apparatus 10, depicting the thermal energy transfer from the stored liquid contents 28 to the food product 30 via the planar lid surface 18. The air molecules within the apparatus 10 become heated and volatile and transfer heat by convection to a trailing planar lid surface 32. Once the radiant heat is absorbed by the planar lid surface 18, it is then transferred to the food product 30 which is in direct communication. The uniform material thickness has a high heat transfer coefficient and quickly absorbs the radiant heat and uniformly transfers it to the planar lid surface 18.

It will be appreciated by persons skilled in the art that the present invention is not limited to what has been particularly shown and described hereinabove. In addition, unless mention were made above to the contrary, it should be noted that all of the accompanying drawings are not to scale. A variety of modifications and variations are possible in light of the above teachings without departing from the following claims.

What is claimed is:

1. A hot beverage container apparatus to provide a conductive heat transfer to a stored food, the apparatus comprising:
a container element further including a substantially planar lid surface configured to transfer a heat source from a stored liquid to at least a releasably positioned food item stored on the substantially planar lid surface.

2. The apparatus of claim 1, wherein the substantially planar lid surface of the container element further includes a bottom surface and a top surface; the bottom surface configured to receive the heat source from the stored liquid, and a top surface configured to uniformly transfer the heat source to the releasably positioned food item.

3. The apparatus of claim 2, wherein the substantially planar lid surface of the container element further includes at least one aperture to allow a user to at least drink and refill the stored liquid.

4. The apparatus of claim 1, wherein the containing element is further comprised of a uniform porcelain material.

5. The apparatus of claim 4, wherein the containing element further includes a molded handle attached to a surface of an outer sidewall.

6. A pastry warming beverage container apparatus, the apparatus comprising:
a substantially cylindrical container including a uniform sidewall and a planar lid surface to provide thermal conductivity from a stored liquid to a releasably attached food product.

7. The apparatus of claim 6, wherein the planar lid surface of the substantially cylindrical container is comprised of a uniform porcelain material to enable uniform heat transfer to the food item and enhance a flavor compound release.

8. The apparatus of claim 7, wherein the planar lid surface further includes at least one aperture to enable a user to at least access, re-fill, and clean the store liquid.

9. The apparatus of claim 6, wherein the substantially cylindrical container further includes a handles affixed at a first end and second end of the sidewall.

10. The apparatus of claim 10 wherein the handle is comprised of a material to prevent the uniform heat transfer from the stored liquid contents to a user hand.

11. A pastry warming beverage container apparatus, the apparatus comprising:
a substantially cylindrical beverage container including a uniform thickness planar lid surface and a sidewall to provide a heated planar lid surface configured to warm a food product using a heat source from a stored liquid contents.

12. The apparatus of claim 12, wherein the planar lid surface further includes at least one elliptical configured aperture to enable a user to access the stored liquid contents.

13. The apparatus of claim 12, wherein the cylindrical beverage contains is comprised of a uniform thickness porcelain material.

14. The apparatus of claim 14, wherein the cylindrical beverage is comprised of a material with a high heat transfer coefficient.
